(19) United States
(12) Patent Application Publication
(10) Pub. No.: US 2019/0267223 A1
(43) Pub. Date: Aug. 29, 2019

(54) HOLDER WHICH INTEGRATES MULTIPLE SAMPLE PLATFORMS FOR MASS SPECTROMETER ANALYSIS

(71) Applicant: Brian G. Healey, Scituate, MA (US)

(72) Inventor: Brian G. Healey, Scituate, MA (US)

(21) Appl. No.: 16/279,987

(22) Filed: Feb. 19, 2019

Related U.S. Application Data
(60) Provisional application No. 62/632,090, filed on Feb. 19, 2018.

(51) Int. Cl. H01J 49/04

(52) U.S. Cl. CPC H01J 49/0418

(57) ABSTRACT

The present invention is a sample plate holder that can be used with mass spectrometry, and more specifically with matrix assisted laser desorption ionization (MALDI) mass spectrometry. This sample plate holder is constructed with an opening mechanism that accepts sample plates of varying materials and sizes. The sample plates are precisely aligned and oriented and securely situated within the holder. This holder may be used in commercially available MALDI mass spectrometers to obtain mass spectra of chemical and biological samples.

### RELATED U.S. APPLICATION DATA

Provisional application No. 62/632,090, filed on Feb. 19, 2018.

### BACKGROUND OF THE INVENTION

The present invention relates to a sample platform holder for use in mass spectroscopy including matrix assisted laser desorption/ionization (MALDI) mass spectroscopy (MS). The holder enables analysis of samples prepared on a multitude of sample preparation platforms through precise alignment and registration of the platform within multiple mass spectrometer instruments expanding the potential sample substrates that can be analyzed by mass spectroscopy.

During the past three decades the use of mass spectrometry for bioanalysis has expanded and become a critical technology in understanding biological systems. The detection of biomolecules using mass spectrometry is challenging due to the extreme variation of their characteristics. Some samples are liquid, such as cell or tissue lysates, blood, or urine, while others are solid such as biopsies, tissue slices or cell pellets, with the sample form typically dictating the type of mass spectrometry that can be utilized for analysis. Samples that are solid in form can be analyzed by a variety of techniques that offer significant advantages in acquisition speed, sample throughput and a microtiter plate format that allows the use of high throughput technologies increasing efficiency. The techniques of Matrix Assisted Laser-Desorption Ionization (MALDI), Desorption Electrospray Ionization (DESI), Laser Ablation Electrospray Ionization (LAESI) and Liquid Extraction Surface Analysis (LESA) all utilize solid supports for samples and benefit from the increase in sample throughput and laboratory automation.

An emerging area of rapid development and significant impact using these techniques is the imaging of biological tissues and cells. Imaging mass spectrometry produces spectra containing hundreds of individual molecules from discrete regions within complex samples, such as a tissue sample, simultaneously. This capability to measure localized levels of biomolecules within a biologically diverse sample offers the potential to study the complex conditions that exist concurrently within the body providing unbiased insight into biological process, disease progression and drug metabolism. In imaging mass spectrometry by MALDI-MS, microscope slides coated with the electrically-conductive indium tin oxide (ITO) act as the biological support allowing both light microscopy data and mass spectra to be collected from the same samples. In order to collect mass spectra from the samples on the ITO-coated slides, slides must be mounted into an additional holder for two microscope slides. The requirement for an additional holder burdens the user with additional expensive and limits the full utility of the mass spectrometer and limits the use of larger biological samples and panels of samples.

Of these techniques, MALDI-MS is the most established and widely used in biological mass spectrometry, as this method ionizes large biological molecules, such as proteins, without fragmenting them. The resulting spectra show discrete profiles of these large biological molecules providing very useful biological activity data. The sample preparation techniques vary greatly depending on the type of biomolecules being analyzed, with hundreds of associated matrix substrates and their related sample supports necessary for mass spectrometric analysis.

Although utilization of mass spectroscopy has continued to grow in both academic and industrial environments, the application and utilization of it in High Throughput Screening (HTS) has been limited. A major limitation for mass spectrometry's use in HTS is the lack of diverse, cost-effective, disposal platforms as sample plates. For researchers processing 10,000 samples per day, the labor-intensive, solvent-requiring, space-limiting steps needed to clean and then re-use sample platforms is a limiting factor. The use of new sample plates instead of washing and re-use will eliminate the potential of carry-over, which may interfere in signal and generate false-positive information. Additionally the limitation of current HTS-compatible sample platforms, namely stainless steel, hinders the analysis of many samples types such as cells by MALDI-MS and prevents implementation of new sample platforms based on advanced ionization techniques. The inventor has extensively studied various plate matrixes and can replicate with accuracy the 384-well plate typically used in high throughput screening.

This present invention will allow for varied cost-effective sample platforms to be integrated within, thereby reducing research time, funds, cross-contamination and biohazard waste. The compatibility with high throughput instrumentation will enable increased utilization of mass spectrometry in HTS and implementation of new ionization techniques earlier into the drug discovery process. The use of the holder in imaging mass spectrometry will provide single solution for the presenting samples into mass spectrometers, increase instrument utilization by allowing analysis of four tissue specimen slides and allow for studies on larger tissue specimens. A further benefit of this invention is it allows for the practical storage of sample on sample plates. As this invention incorporates numerous cost effective disposable sample plates, a researcher is not forced to clean each sample plate to re-use the costly device, thereby destroying the sample on the sample plate. The storage of the disposable sample plates will allow for the analysis or re-analysis of dried samples at a later time.

### SUMMARY OF THE INVENTION

The invention provides a holder for introduction of samples into a mass spectrometer on a multitude of sample preparation platforms and relates generally to mass spectrometry and the analysis of chemical and biological samples. The holder makes use of a precise alignment slot that allows registration of a sample plate with exquisite accuracy and correct sample orientation. The sample plates are locked into the holder with a hinge that ensures accurate electrical contact between the holder, sample plate and mass spectrometer. Aspects of the present invention allow for the use of changeable sample plates, such as, but not limited to, metallic substrates such as stainless steel or glass substrates, fitted into a holder providing facile mounting of plates. The holder dimensions are consistent with commercially available products used in mass spectrometry and microplate instrumentation while accommodating sample substrates of varying sizes as commonly utilized in a laboratory. Sample plates can be utilized as single-use disposable devices or utilized for sample archiving and re-analysis.

### BRIEF DESCRIPTION OF THE DRAWINGS

The present disclosure is to be considered as an exemplification of the invention and is not intended to limit the invention to the specific embodiments illustrated by the figures or description below.

FIG. 1 is an exploded view of the mass spectrometric substrate holder, associated clamp and separate sample plate.

FIG. 2 depicts a preferred embodiment of the assembled sample plate holder and clamp with sample plate inserted into alignment slot. The clamp is in the open position allowing the insertion or removal of a sample plate into the holder.

FIG. 3 is a cross-sectional view of the middle of the holder with mass spectrometric sample plate inserted into the alignment slot.

FIG. 4 is a cross-sectional view from the top of the plate depicting the bottom of the alignment slot with which the mass spectrometric sample plate sits upon.

FIG. 5 is a cross-sectional view of the back of the holder depicting hole-patterns for attaching the holder clamping mechanism using shoulder bolts (not shown).

FIG. 6 depicts 3 detailed views of the clamp, including placement of the magnetic closure holes, a 3D rendering of the clamp indicating the threaded holes on the ends for the hinge, and a cross sectional view of the magnetic closure and threaded shoulder bolt holes.

### DETAILED DESCRIPTION

The present invention is a sample plate holder that may be used for mass spectrometry imaging of cells, tissues, mixtures or suitable specimen, or with compatible analytes. In the terminology used within, the term plate, and/or sample plate will refer to any plate, slide, substrate, wafer, or sample presentation apparatus as used in a laboratory to prepare a sample for introduction into a mass spectrometer or similar laboratory piece of equipment. The use of the terms plate and/or sample plate is used for continuity and simplicity and is not intended to be limiting to these stated forms, and do not preclude the presence or addition of other components, elements, or groups thereof.

The preferred embodiment described is representative of the present invention. Although the present invention has been illustrated and described herein with reference to preferred embodiments and specific examples therein, it will be readily apparent to those of ordinary skill in the art that other embodiments and examples may perform similar function and/or achieve results. All equivalent embodiments and examples are within the spirit and scope of the present invention and are contemplated thereby, and are intended to be covered.

Reference is herein made to the included figures, wherein the numerals representing particular parts of the present invention are consistently used throughout the figures and accompanying discussion.

This present invention addresses limitations in commercially available sample plate holders for use in mass spectrometry, and specifically MALDI mass spectrometry, and other sample analysis apparatuses. The limitations include the prohibitive cost of commercially available sample plates; the lack of compatible glass slides or plates; the labor-intensive, biohazard waste-producing, hood-based cleaning procedures required to reuse plates.

This invention will also provide the realistic option of the storage of samples on plates for analysis or re-analysis at a later time which is an important benefit as sample quantity available is quite often limited.

The overall intention of this invention is to provide a sample plate holder for use in mass spectrometry, or alternate instrument, consisting of a rigid frame with an opening to accommodate the exchange of sample substrate plates. While the sample plates may be cleaned and re-used, the preferred embodiment allows for the replacement of new sample plates within the plate frame. The plate frame is constructed to hold sample plates of varying dimensions and materials, including, but not limited to, stainless steel, silicon wafers, glass, and plastic. The present invention is of the standard dimension to be compatible with commercially available instrumentation, while allowing for plates to be interchangeable within the plate frame.

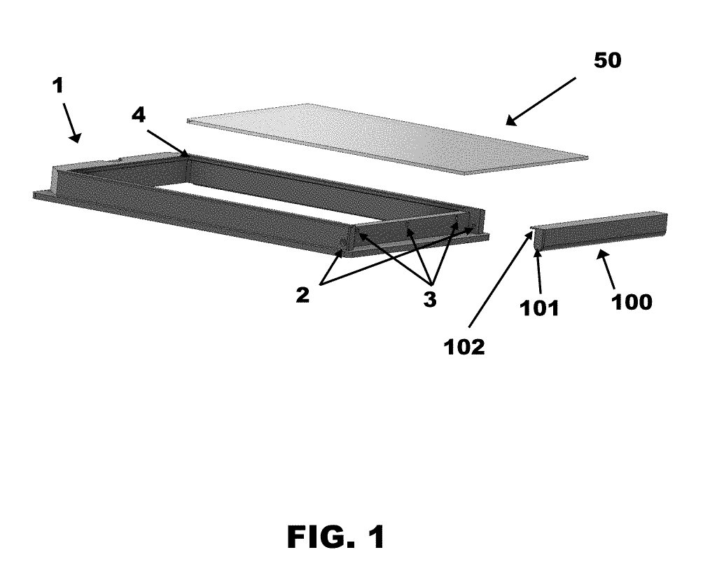

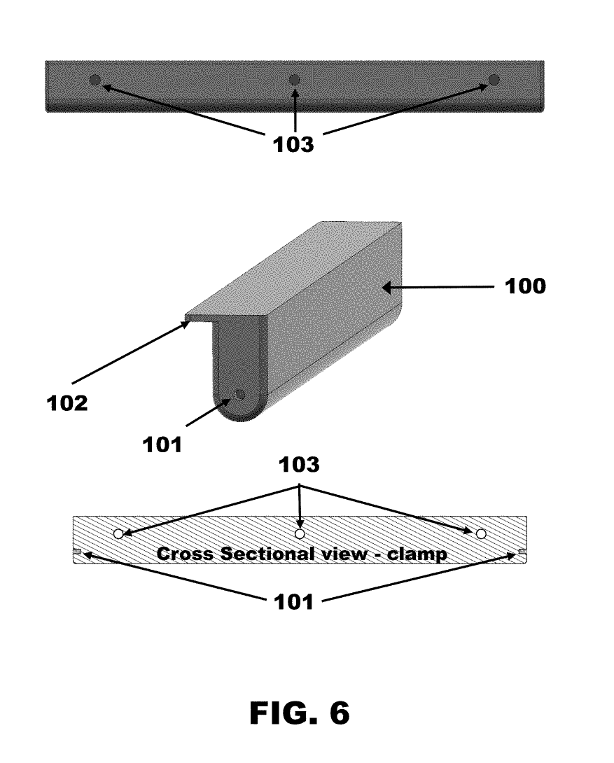

FIG. 1 depicts the sample plate holder in an exploded view. The clamp 100 is displayed as separated from the sample holder 1 and the insertable sample plate 50. Machined holes 2 and 3 are visible in this view, which are connection points for the clamp 100. The clamp 100 is attached to the sample holder frame 1 via shoulder screws, not shown, inserted through machined holes 2 in the plate holder and screwed into threaded-holes 101 in the clamp forming a hinge. The clamp in the closed position will secure the sample plate 50 in the alignment slot 4 of the sample holder frame 1. The substrate 50 is secured in place by clamp flange 102 when magnets located in holes 3 in the holder engage with the holes 103 on the clamp. This interaction is further depicted in FIG. 6.

In the preferred embodiment, Frame 1 is constructed of stainless steel with a hinged opening. This hinged opening is the vehicle allowing the sample plates to be inserted, removed, and/or replaced into the frame. While the preferred embodiment contains a hinged clamp, the device is not limited by this clamp or other clamp systems in design or materials. The frame provides a secure setting for the changeable sample plates to be used seamlessly for mass spectrometry analysis, as well as with commonly used laboratory methods and apparatuses. This sample holder will accept varying sample plates, such as, but not limited to, metallic substrates such as stainless steel or conductively-coated glass substrates, fitted into a holder providing facile mounting of plates. This holder accepts the glass slides commonly used in laboratory arts, such as histology. This design advancement of this invention allows for glass slides to be analyzed by mass spectrometry, and it provides for the unique sample to be used in multiple scientific tests, providing analysis of the unique sample allows for absolute cross testing and data comparison and reduces sample size required, sample preparation time, labor, and laboratory supplies.

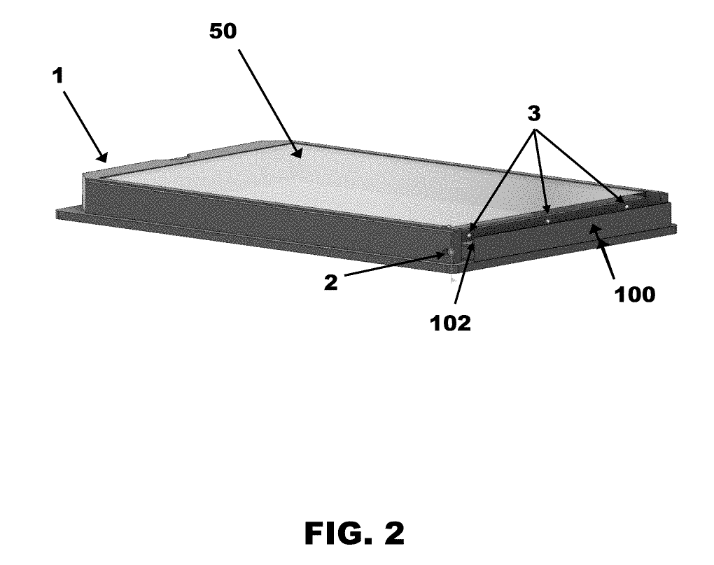

FIG. 2 depicts the sample holder 1 with the sample plate 50 inserted into the alignment slot with the clamp 100 in the open position allowing insertion or removal of sample plate 50. The machined holes 3 with associated magnets are visible. The threaded holes 101 for the shoulder screws which connect the sample frame 1 with the clamp 100 are visible through the machined hole 2.

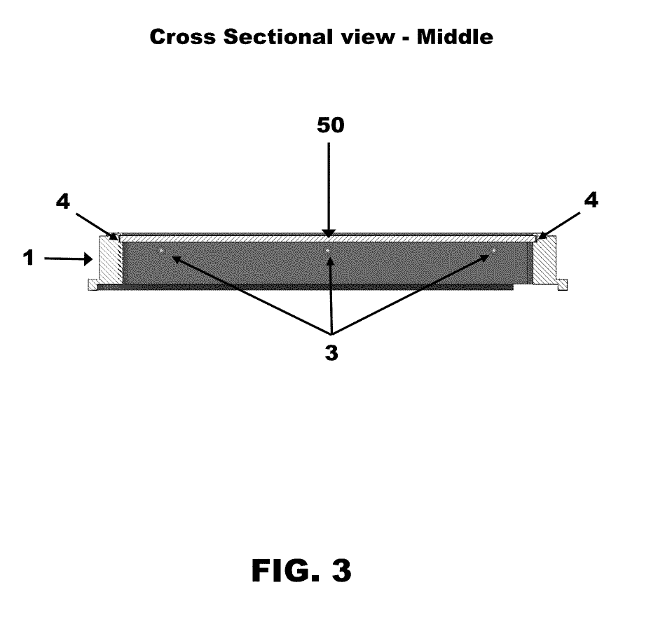

FIG. 3 depicts the inserted sample plate 50 resting on the alignment slot 4 of the plate holder 1 viewed with the clamp 100 in the open position. This figure depicts the precise dimensional tolerances of this invention. The precise dimensional tolerances of sample plate 50 and slot 4 are very important in the analysis by mass spectrometer. The sample plate and any associated sample plate holder must adhere to strict dimensions of the combined height of the sample plate and any associated holder required by the mass spectrometer for the ionization of the sample to be achieved. Incorrect height dimensions will interfere with the ionization process and impact the resulting spectra.

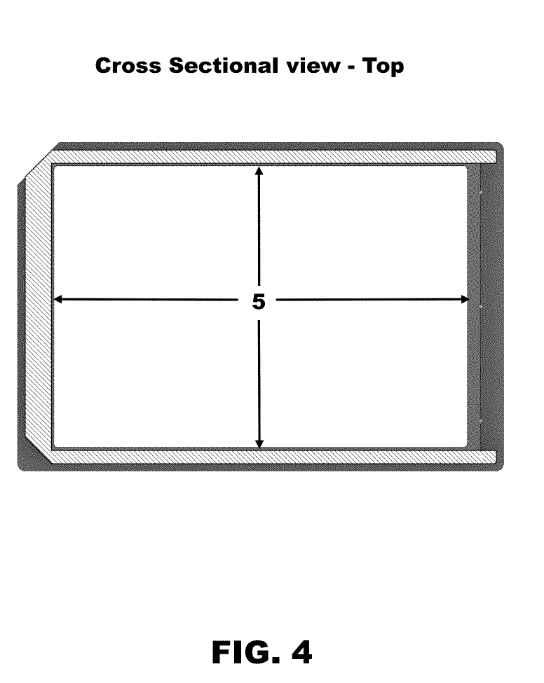

FIG. 4 depicts a top-down cross-sectional view of the sample holder frame 1 highlighting the bottom of alignment slot 4 for maintaining samples at the proper height for mass spectrometry detection relative to the bottom of the frame. 5 indicates the tight tolerances of the sample plate and the plate holder. The plate frame securely holds the sample plate within the frame. This view depicts the sample plate resting on the alignment slot though the alignment slot itself is not visible. The reproducible tight tolerances are critical for accurate ionization by the mass spectrometer of the chosen sample site by precise x,y components. A feature of the MALDI mass spectrometer is that it performs its analysis on a distinct x,y coordinate of the sample plate. As an example, a sample plate may have 384 distinct regions correlating to 384 individual samples. The mass spectrometer is equipped to distinguish each of the 384 regions, as well as distinct locations within each region. An important feature of this invention is the dimensional tolerance of the sample plate holder and the various sample plates that allow for precise and reproducible registration of the samples in the mass spectrometer.

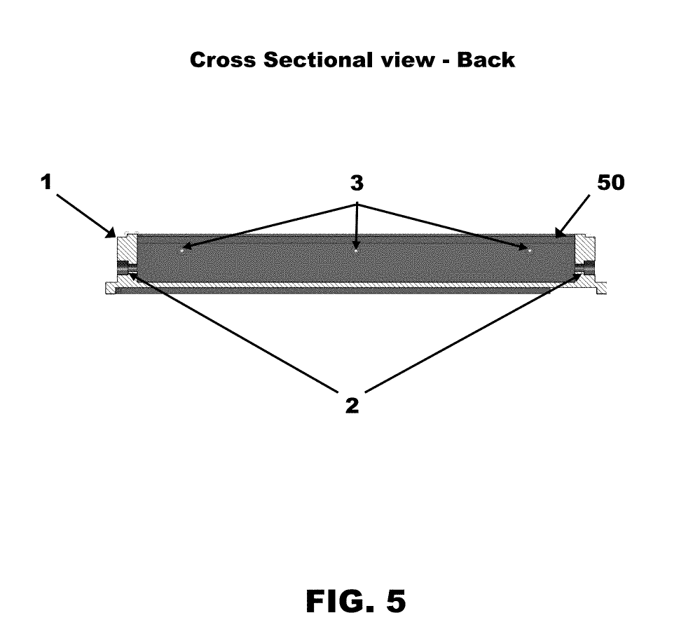

The cross-sectional view in FIG. 5 depicts the concentric holes on the sides of frame 1 that act as hinge points for the clamp 100 when the holder is assembled using shoulder screws inserted into 2 and the threaded holes 101 in the clamp 100.

FIG. 6 depicts the clamp 100 in detail. The top image shows the placement of the magnetic closure holes 103 on the interior side of the clamp. The center image is the clamp 100 in 3 dimensions with the clamp flange 102 and threaded-hole 101 visible. The bottom image is a cross-sectional view of the clamp depicting the magnetic closure holes 103 and threaded shoulder bolt holes 101.

What is claimed is:

1. A sample plate holder for mass spectrometry analysis comprised of:
a rigid frame with a precise alignment slot that accepts a sample plate and imparts precise alignment and correct sample orientation to the mass spectrometer;
a clamping mechanism attached to the rigid frame which allows for insertion or removal of a sample plate and will securely hold and ensure electrical contact between the sample plate and holder when in the locked position;
a sample plate of strict dimension to properly fit in the holder in a single orientation ensuring accurate sample registration and of a material is suitable for, but not limited to, MALDI mass spectrometry

2. The structure of claim 1 wherein the sample plate comprises a material from group consisting of stainless steel, conductive-metals, conductive-glass, conductive-wafer, conductive polymer and type III-V semiconductor.

3. The structure of claim 1 wherein the sample plate material comprises four indium tin oxide coated 25mm x 75mm glass microscope slides.

4. The structure of claim 1 wherein the sample plate contains identity markings in the form of letters, numbers or a barcode.

5. The structure of claim 1 comprising of an optional gasket may be comprised of, but not limited to, silicone rubber, or other material appropriate to the experimental conditions. Said optional gasket may be used for, but not limited to, proper placement of sample on the sample plate, as sometimes referred to as plate well; separation of samples on the sample plate; to provide pressure to ensure that the sample plate remains in correct position.

6. The structure of claim 1 where the clamping mechanism utilizes magnets to secure the sample plate in the locked position.

7. The structure of claim 1 where the clamping mechanism utilizes mechanical locking with screws to secure the sample plate in the locked position.
